(19) United States
(12) Patent Application Publication
(10) Pub. No.: US 2018/0299067 A1
(43) Pub. Date: Oct. 18, 2018

(54) PRESSURE VESSEL

(71) Applicant: UNIVERSITY OF CAPE TOWN, Cape Town (ZA)

(72) Inventors: Stuart Graves SWAN, Cape Town (ZA); Arnaud George MALAN, Cape Town (ZA)

(73) Assignee: UNIVERSITY OF CAPE TOWN, Cape Town (ZA)

(21) Appl. No.: 15/766,145

(22) PCT Filed: Oct. 5, 2016
(86) PCT No.: PCT/IB2016/055955

§ 371 Date: Apr. 5, 2018

(30) Foreign Application Priority Data
Oct. 7, 2015 (GB) 1517711.6

(51) Int. Cl. F17C 1/06; F17C 1/16; F17C 13/06

(52) U.S. Cl. CPC F17C 1/06; F17C 2270/0197; F17C 13/06; F17C 2201/0109; F17C 2203/0604; F17C 2203/0619; F17C 2203/0663; F17C 2203/0685; F17C 2205/0323; F17C 2205/0394; F17C 2209/227; F17C 2209/232; F17C 2209/234; F17C 2260/012; F17C 2270/0194; F17C 1/16

(57) ABSTRACT

A pressure vessel (100) is provided which includes a tubular body (101) constructed from a composite material. A pair of end caps (103, 105) are adhesively secured to opposite ends (107, 09) of the body (101). A flexible, fluid impervious lining (111) is provided internally of the body (101). The flexible, fluid impervious lining (111) is formed from a thin coating applied to the body so that the pressure vessel (100) is sufficiently lightweight.

### CROSS-REFERENCE(S) TO RELATED APPLICATIONS

This application claims priority from United Kingdom patent application number 1517711.6 filed on 7 Oct. 2015, which is incorporated by reference herein.

### FIELD OF THE INVENTION

This invention relates to a pressure vessel. In particular, it relates to a lightweight pressure vessel and methods of manufacture thereof.

### BACKGROUND TO THE INVENTION

Pressure vessels are containers that may be used to store fluids, in particular gases, liquids, or mixtures thereof. Pressure vessels are usually made of metal that is fluid impermeable such that the contents of the vessels are sealed therein.

Some pressure vessels are used in rockets or as propulsion thrusters in aerospace technology. Such pressure vessels need to be lightweight and able to withstand high pressure in order to enhance their propulsion capabilities.

It may also be advantageous to use lightweight pressure vessels for gas storage purposes to decrease transport costs and for ease of handling.

Many lightweight materials used for the manufacture of lightweight vessels, including composite materials, are either porous or include a resin that may form micro cracks when the resin is subjected to forces derived from gas pressure within the vessel or the like.

Known methods of manufacturing lightweight pressure vessels include the use of a substantially impermeable lining within the vessel. The lining is usually preformed, where after the lightweight pressure vessel is formed around the lining. This method of manufacture usually requires a substantial amount of specialty machinery and is generally time-consuming. Moreover, the preformed lining usually has a substantial mass so that it has the required structural integrity to allow the formation of the pressure vessel about the lining. This then adds to the overall mass of the vessel.

There is thus a need for a lightweight pressure vessel and a simple method of manufacture thereof that alleviates the abovementioned problems, at least to some extent.

In this specification the term “composite material” shall have its widest meaning and include any material made from fibres and a matrix. The term “carbon fibre” shall have its widest meaning and include a carbon fibre reinforcement which is incorporated in a composite material.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with a first aspect of the invention, there is provided a pressure vessel which includes a tubular body constructed from a composite material and a pair of end caps adhesively secured to opposite ends of the body, characterised in that a flexible, fluid impervious lining formed by a coating applied to the body is provided internally of the body.

Further features of the invention provide for the coating to be a thin layer of a fluid elastomeric material, preferably a rubber or rubber-like material, which is applied to the body and cured to form the flexible, fluid impervious lining; and for the lining to have a thickness of less than 1mm, preferably less than 0.5 mm, more preferably about 0.2 mm.

Yet further features of the invention provide for the end caps to be secured, at least partially, within respective ends of the body; for each end cap to provide a complementary fit within an end of the body and include a circumferential channel into which an adhesive can be introduced to secure the end cap in position; for one or more ports to be provided in each end cap for introducing an adhesive in the circumferential channel with the end cap located within the body; and for the adhesive to be an epoxy adhesive.

A further feature of the invention provides for the end caps to be made from a fluid impervious material, preferably a plastics material.

Still further features of the invention provide for the body to be right cylindrical in shape; and for the composite material to be a carbon fibre composite material.

A further feature of the invention provides for a valve or spout to be provided in at least one end cap.

In accordance with a second aspect of the invention, there is provided a method of manufacturing a pressure vessel, the method including the steps of:
coating an internal surface of a tubular body made of a composite material to form a flexible, fluid impervious lining; and
adhesively securing an end cap to each end of the body.

A further feature of the invention provides for the internal surface of the body to be coated with a fluid material, preferably an elastomeric material, and for the material to be permitted to cure or set to form the flexible, fluid impervious lining.

Further features of the invention provide for each end cap to be secured in position by positioning the end cap within an end of the body so that the end cap is at least partially received within the end of the body and introducing an adhesive into a circumferential channel on the end cap such that the adhesive extends between the end cap and internal surface of the body; and for the adhesive to be introduced into each circumferential channel through one or more ports in the end cap.

According to a further aspect of the invention the lining is provided by a thin and flexible fluid, impervious sleeve.

An embodiment of the invention will now be described, by way of example only, with reference to the accompanying drawings.

### BRIEF DESCRIPTION OF THE DRAWINGS

In the drawings:

FIG. 1 is a sectional side elevation of a pressure vessel;

FIG. 2A is a front end elevation of a first end cap in FIG. 1;

FIG. 2B is a sectional side elevation along II-II of the end cap in FIG. 2A;

FIG. 3A is a front end elevation of a second end cap in FIG. 1;

FIG. 3B is a sectional side elevation along III-III of the end cap in FIG. 3A;

FIG. 4 is a sectional side elevation of the end cap in FIGS. 2A and 2B secured within an end of the tubular body with adhesive being injected into a port in the end cap;

FIGS. 5A and 5B are sectional side elevations of the tubular body and first end cap with a foam sponge on a dowel rod used in coating the internal surface of the tubular body with a fluid impervious lining material;

FIG. 6 is a sectional side elevation of the tubular body with the first end cap secured to one end and a second end cap being positioned within the opposite end;

FIG. 7 is a sectional side elevation of the pressure vessel in FIG. 6 with sockets formed therein adjacent either end;

FIG. 8 is a sectional side elevation of the pressure vessel in FIG. 7 with the sockets filled with adhesive;

FIG. 9 is a sectional side elevation of the pressure vessel in FIG. 8 with a sleeve secured over each end; and

FIG. 10 is a sectional side elevation of a further embodiment of a pressure vessel with a sleeve secured internally thereof.

### DETAILED DESCRIPTION WITH REFERENCE TO THE DRAWINGS

A pressure vessel is provided which includes a tubular body constructed from a composite material and a pair of end caps adhesively secured to opposite ends of the body. A flexible, fluid impervious lining formed by a coating applied to the body is provided internally of the body. The word “coating” refers to a thin layer of material formed by coating a surface with the material. In this case an internal surface of the tubular body is coated with a material. The material may be in fluid or liquid form while it is being applied or coated onto the internal surface and is then allowed to cure or set to form a substantially solidified flexible, fluid impervious lining. For convenience, in this specification the term “cure” shall denote any process in which a fluid or liquid coating substantially solidifies. The coating may be applied by any suitable method such as spraying, painting, brushing, vapour deposition, spin coating or dip coating and any suitable applicator or device may be used to apply the coating. One or several coatings or layers may be applied to form the lining.

The material used to during the coating process may be fluid or liquid and should cure or set when exposed to the atmosphere and/or heat. The material should preferably cure without shrinking or with negligible shrinkage. The material may be an elastomeric material, preferably a rubber or rubber-like material such as a liquid urethane rubber of a selected hardness, tear resistance and the like. Ideally, the coating is applied at a controlled thickness. The eventual fluid, impervious lining that is formed by the coating process may have a thickness of less than 1 mm, preferably less than 0.5 mm, more preferably about 0.2 mm.

End caps of any suitable shape or size are adhesively secured to opposite ends of the hollow tubular body of the pressure vessel. The end caps should also be fluid impervious and preferably made of a lightweight material such as a plastics material although any other fluid impervious material such as metal may be used. The end caps may be secured to the body with an adhesive applied to an interior or exterior surface of the tubular body, or both the interior and exterior surfaces simultaneously as long as the adhesive provides a dominantly shear connection between the end caps and the tubular body under pressurisation. A dominantly shear connection is a connection or joint in which the adhesive that forms the connection or joint experiences a dominantly shear force when the pressure vessel is pressurised in use. It has been found that most adhesives are significantly stronger in shear than in tension and thus the end caps are adhesively secured to the tubular body with an adhesive bond which is dominantly in shear when the tubular body of the pressure vessel is pressurised.

To provide a dominantly shear connection between the end caps and the tubular body, the end caps are preferably received, at least partially, within respective ends of the tubular body of the pressure vessel and secured internally of the body. Although each end cap may be secured internally of the body of the pressure vessel, a part of each end cap may extend beyond the ends of the body. Each end cap may provide a complementary fit within an end of the body and may include a circumferential channel into which an adhesive can be introduced to secure the end cap in position. The circumferential channel is configured to contain the adhesive that bonds the end caps to the tubular body and may be shallow. The shape and size of the channel may be adapted to ensure a sufficiently strong and dominantly shear connection between the end caps and the body, preventing the end caps from being expelled from the body when the pressure vessel is pressurised. The channel has a selected width for adhesively bonding sufficiently large surface areas of the end caps and the tubular body together to enhance the strength of the adhesive bond.

The end caps may include one or more ports, each having an inlet in fluid communication with the circumferential channel for introducing an adhesive such as an epoxy adhesive, in the circumferential channel while the end cap is located within the body.

The tubular body of the pressure vessel may have any suitable size and further fittings may be provided depending on the intended application or use of the pressure vessel. The tubular body may be right cylindrical in shape and may be formed from any composite material, preferably a lightweight but strong composite material. The composite may be reinforced with fibres such as carbon or glass fibres.

A method of manufacturing a pressure vessel is also provided. The method includes the steps of coating an internal surface of a tubular body made of a composite material to form a flexible, fluid impervious lining and adhesively securing an end cap to each end of the body. The step of coating the internal surface of the body includes coating the body with a fluid material which is allowed to cure or set to substantially solidify into a flexible, fluid impervious lining. The composite body is manufactured first, so that it can thereafter be coated with a material such as an elastomeric material in fluid or liquid form which will form the lining once cured or set. The lining formed by the coating adheres to the body once it has been formed and it makes parts of the body that are coated therewith fluid impervious.

As previously mentioned, any suitable method such as spraying, painting, brushing, vapour deposition, spin coating or dip coating and any suitable applicator or device may be used to apply the coating. The coating may be applied by a sponge of a selected size provided on an end of a support such as a dowel rod which is plunged into the body of the pressure vessel as will be described more fully further below.

Each end cap is secured in position by positioning the end cap within an end of the body so that the end cap is at least partially received within the end of the body. An adhesive such as an epoxy adhesive is introduced into the circumferential channel on the end cap such that the adhesive extends between the end cap and internal surface of the body to bond the end cap to the body. The adhesive may be introduced into each circumferential channel through one or more of the ports in the end cap. The unused ports may provide ventilation which enable the adhesive to cure, if required.

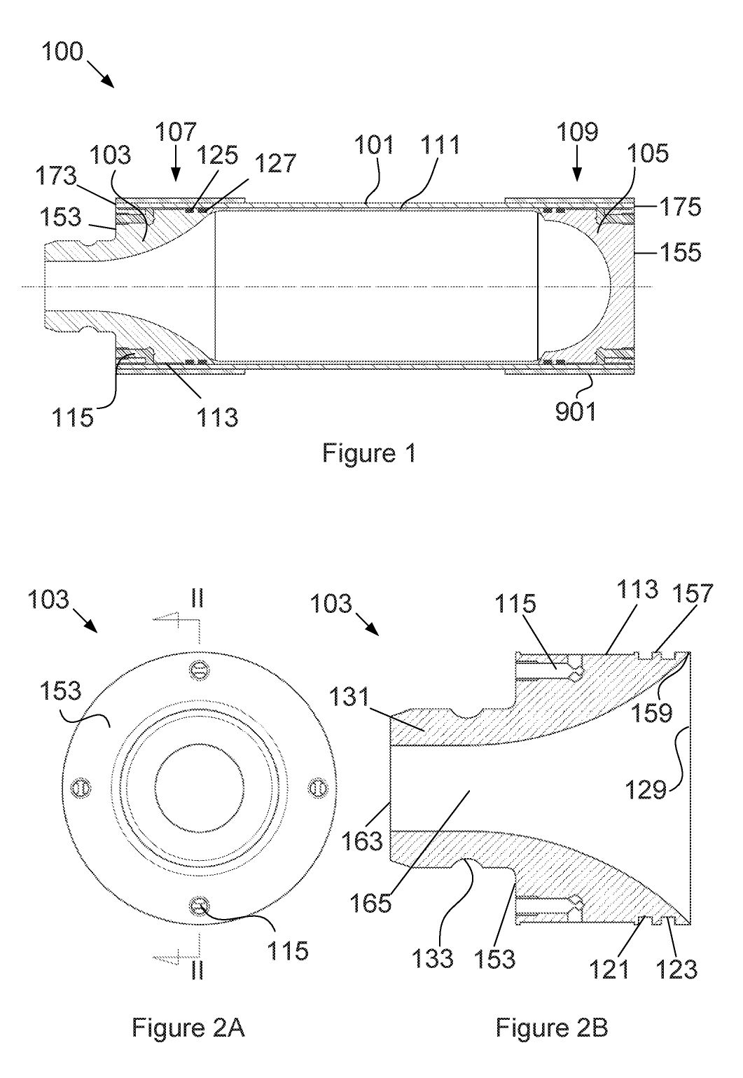

An embodiment of a pressure vessel (100) is shown in FIG. 1 and includes a tubular body (101) which, in this embodiment, is right cylindrical in shape and is constructed from a carbon fibre composite material. A pair of end caps (103, 105) are secured to opposite ends of the tubular body (101) and a flexible, fluid impervious lining (111) is provided internally of the body (101). The flexible, fluid impervious lining (111) is formed by a coating applied to an internal surface of the body (101).

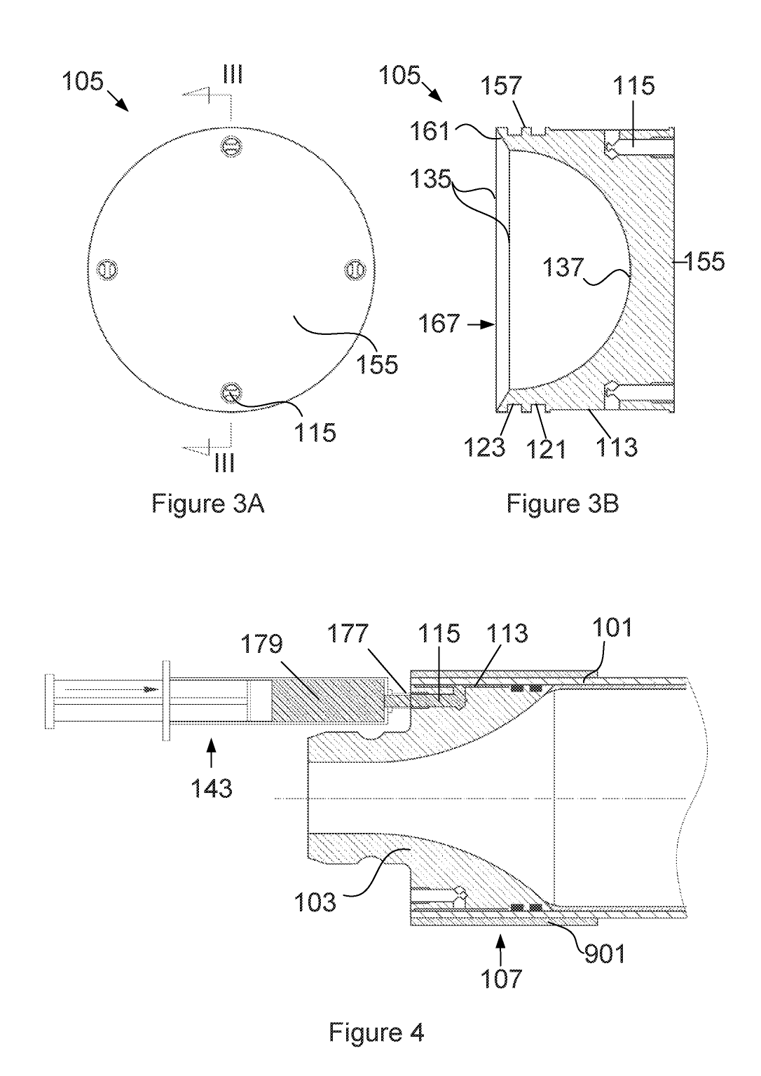

Referring also to FIGS. 2A to 3B, the end caps (103, 105) are generally cylindrical in shape and are dimensioned to provide a complementary fit within respective ends (107, 109) of the body (101). A shallow circumferential channel (113) or trough is provided about the outer surface of each end cap (103, 105) adjacent its operatively outermost end (153, 155). In this embodiment each channel is approximately 0.5 mm deep. Ports (115) are provided which extend from the outer end (153, 155) to centrally within each channel (113). In this embodiment four equally spaced ports (115) are provide on each end cap (103, 105), these each having a generally L-shape as shown more clearly in FIGS. 2B and 3B. With the end caps (103, 105) located within the respective ends of the body (101) the ports (115) permit fluid communication with the respective channels (113) from the exterior for reasons that will be made more apparent below.

Furthermore, each end cap (103, 105) has a pair of circumferential grooves (121, 123) in its outer surface (157) adjacent its operatively innermost end (159, 161) and an O-ring (125, 127) is provided in each groove (121, 123).

The end caps (103, 105) are made from a fluid impervious material, in this embodiment a plastics material, and can be made using any suitable method. Also in this embodiment, the end caps (103, 105) are machined on a computer numerical control (CNC) lathe from polyvinyl chloride (PVC).

As shown more specifically in FIGS. 2A and 2B, the end cap (103), for convenience referred to as the “first end cap”, includes a spout (131) or spigot which extends axially from the outer end (163) with a flow passage (165) extending from the end of the spout (131) to the inner end (129) of the end cap (103). In this embodiment the flow passage (165) has a funnel-like shape and tapers from the circumference of the inner end (129) to centrally within the spout (131).

A circumferential groove (133) is formed about the spout and configured to cooperate with a quick-release coupling (not shown).

As shown more specifically in FIGS. 3A and 3B, the end cap (105), for convenience referred to as the “second end cap”, has a generally flat outer end (155) and a central, inwardly directed concavity or dome (137) in its inner end (167). A bevel (135) is provided around the periphery of the dome (137).

The vessel (100) is assembled or made, in this embodiment, as follows. Carbon fibre composite tube is cut to a desired length to form the body (101) and the ends (173, 175) of the body (101) are sanded to remove any sharp edges.

The first end cap (103) is inserted into an end (173) of the body (101) and tapped gently into position using a rubber mallet until its outer end (153) is flush with the end (173) of the body (101). Referring also to FIG. 4, the nozzle (177) of a syringe (143) filled with an adhesive (179), in this embodiment an epoxy adhesive, is inserted into a port (115) and the syringe then used to introduce the adhesive through the port (115) into the channel (113). More than one syringe can be simultaneously used with the proviso that at least one port should be left open to permit air displaced by the adhesive to vent or escape there through. The open port or ports should be oriented to assist in evacuation of the air.

The O-ring (125) nearest to the circumferential channel (113) assists in preventing spillage and travel of adhesive into the interior of the body during manufacture.

Once the channel (113) is completely filled the epoxy adhesive is then left to cure. Hereafter a reinforcing sleeve (901) is secured over the end (107) of the body (101). The sleeve (901) is conveniently made from a composite material, preferably a carbon fibre composite material and in particular a carbon fibre composite laminate. These are formed by wetting the carbon fibre material in an epoxy resin and then winding the material around the end (107). In a preferred embodiment, the sleeve (901) is made from a carbon fibre twill weave cloth that has approximately twice as many carbon fibres in one direction as the other. When using such cloth it is necessary to ensure that the cloth is in the correct orientation before cutting the sleeves into the desired dimensions as doubling of carbon fibres is required in the radial direction with respect of the cylindrical body to withstand hoop stresses. The epoxy resin used is in this exemplary method of manufacture is allowed to set for approximately 24 hours.

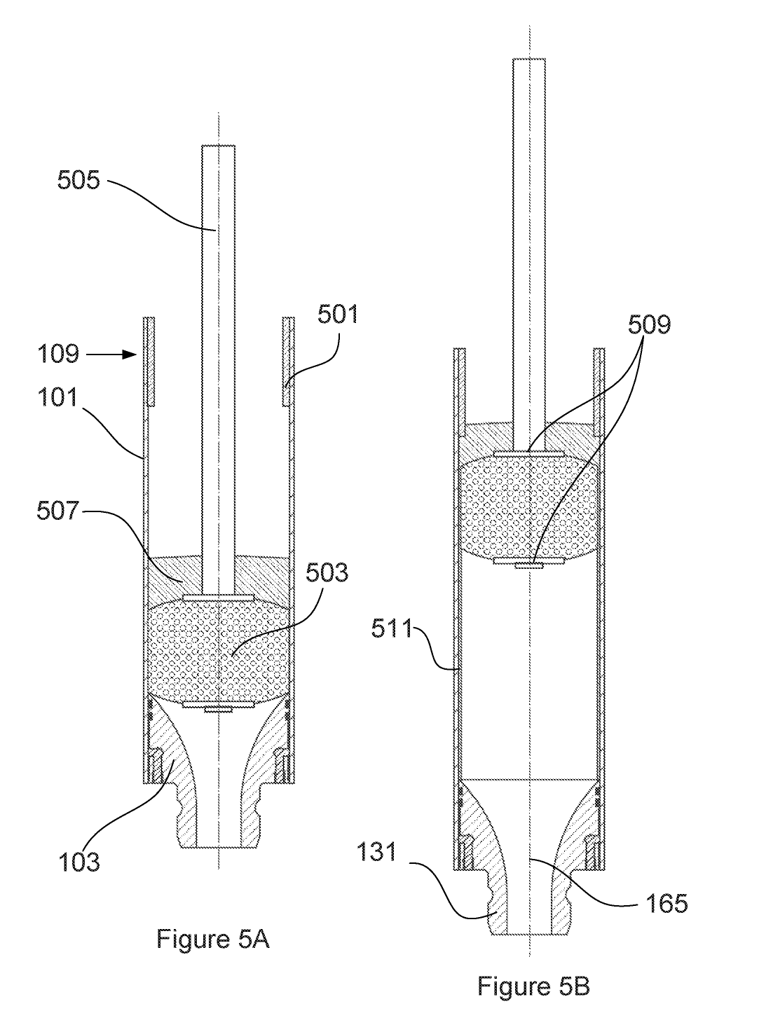

Once the epoxy adhesive has dried and set, the end cap (103) should be adequately secured to the body (101). The opposite internal end (109) of the body (101) is then lined with, in this embodiment, a layer of an adhesive tape (501). Referring to FIGS. 5A and 5B, a foam sponge (503) attached to a dowel rod (505) is then used to apply three thin layers of liquid rubber onto the internal surface of the body. In this embodiment each layer or coat has a thickness of about 0.07 mm. The dowel rod (505) provides a handle to which a generally circular piece of medium density foam (503) is attached between a pair of washers (509). The diameter of the foam (503) is selected to be slightly greater than that of the body (101).

To apply the liquid rubber coating the body is held vertically with the end cap (103) lowermost. The foam sponge (503) is plunged or moved downward towards the end cap (103) until it abuts against the end cap as shown in FIG. 5A. Liquid rubber (507) is poured into the open end of the body and allowed to settle above the foam sponge (503) for approximately 5 minutes. Thereafter, the dowel rod and foam sponge is pulled upwards, in the direction of the tape (501), and then pushed back down, in the direction of the end cap (103). The dowel rod and foam sponge are moved in this manner until liquid rubber starts to drip out of the spout (131) of the end cap (103). The dripping signals that the liquid rubber covers substantially the entire internal surface of the body. The dowel rod and foam sponge are then removed and any excess rubber is wiped off parts of the vessel while it is still liquid.

The tape (501) ensures that no rubber coats the end (109) part of the body (101) which may compromise the adhesive bond between the end cap (105) and the body (101). The tape (501) is removed before the rubber sets and excess liquid rubber is removed from the end cap (103), preferably using a scraping tool with the same contour as the passage (165) through the spout (131).

This first coating (511) of liquid rubber is left to dry and set or cure overnight. Ideally, the body (101) should be mounted on a rotatable shaft so that it is rotated in a horizontal orientation at approximately 10 rpm, for example, on its longitudinal axis. Alternatively, the coating is allowed to dry while the body is in a vertical orientation, and inverted every 3 minutes for an hour, for example, or until the liquid rubber starts to set. Rotation of the body is aimed at substantially preventing the uneven flow of liquid rubber that may result in thinning of the coating in some areas thereof.

Hereafter tape (501) is again adhered to the opposite internal end (109) and a second coating of rubber is applied in substantially the same manner as the first coating. Before cured, the tape (501) is again removed and, after curing of the second layer, a new piece of tape and the third coating are then applied in a similar manner. Before the liquid rubber of the third coating has cured, the tape (501) is removed and the second end cap (105) is inserted into the body. This ensures that the rubber lining extends over the bevel (135) of the end cap (105) to assist in providing a fluid-impervious seal, together with the O-ring (127), between the end cap (105) and the body (101).

The rubber coatings, once cured, form the flexible, fluid impervious lining (111) of the pressure vessel (100).

The second end cap (105) is secured in position in the end (109) of the body (101) in the same manner as the first end cap (103) using an adhesive introduced through one or more ports (115) into the channel (113). The domed recess (137) in the internal end (167) of the end cap (105) assists in maximising the volume of the pressure vessel (100) and in reducing the overall weight thereof.

Thereafter, the entire pressure vessel is finally cured at approximately 50° C. for about 16 hours to cure the epoxy adhesive and rubber liner, preferably with a ramp rate of 10° C./hour. The time allowed for curing and the ramp rate used will depend on the materials used.

The vessel (100) is lightweight yet highly effective. The flexible lining prevents fluid escaping through micro cracks which may form in the composite material. The bond provided by the epoxy adhesive between the end caps and tubular body experiences a shear force which is well within the tolerances for such a bond. The end caps are thus secured in a highly effective manner within the body.

The sleeves (901) minimise tube expansion, in use, when the pressure vessel is pressurised and protect the epoxy adhesive's bond between the body and the end caps.

An embodiment of the pressure vessel made according to the above method has a tubular body with a length of 2200 mm and inside diameter (ID) of 60 mm. The pressure vessel has a volume of 6.25 I, a pressure capacity of 10 MPa and a weight of approximately 1120 g. The pressure vessel has a thin, flexible, fluid impervious rubber lining of approximately 0.2 mm thick. In respect of these dimensions the bonded areas of the end caps experience a shear stress of 6 MPa. This is below the maximum shear stress of 20 MPa that the epoxy adhesive bond of the current embodiment is able to withstand.

Exemplary materials that may be used to make the pressure vessel are listed in Table 1 below.

TABLE 1
List of materials used to make a pressure vessel

| Material | Description | Quantity | | Obtained from |
|---|---|---|---|---|
| Epoxy adhesive | SpaBond 340LV | 1 | kg | AMT Composites |
| Carbon fibre composite | Filament wound carbon | 2.66 m length | | GRP Tubing |
| tube | fibre T700 tube with two | with ID60 mm | | |
| | helix at 55 deg. | | | |
| Rubber for lining | VytaFlex 60 | 2 | kg | AMT Composites |
| O-rings | ID56.5 × 1.8 | 4 | units | BMG |
| PVC for endcaps | Ø65 mm PVC round bar | 500 | mm | Maizey Plastics |
| | to machine End Cap and | | | |
| | Filler End from | | | |
| Carbon fibre laminate | 200 gsm twill weave | 1 | m² | AMT Composites |
| for sleeves | carbon cloth | | | |
| Epoxy resin | Ampreg 21 | 2 | kg | AMT Composites |

The pressure vessel has a reasonably high pressure capacity to weight ratio. Advantageously it is of simple construction and relatively easy to manufacture. It is lightweight as it does not include any heavy parts made of metal, for example. It, is however, foreseen that in some embodiments it may be advantageous to replace the plastic end caps with metal end caps in which case the end caps can be made smaller as it is stronger than plastic.

The performance of a pressure vessel as a water rocket was tested by launching a pressure vessel manufactured as described above from a launch pad. Generally, a water rocket uses water as reaction mass and the pressure vessel is partly filled with water. The water is then forced out of the pressure vessel through the spout by a pressurised fluid, typically compressed air.

The particular pressure vessel tested was 2.23 m in length with an inside diameter of 60 mm and capable of being pressurised to 10 MPa. The complete rocket had a dry weight of less than 1.5 kg, including a flight computer, an on-board camera, a parachute and a parachute deployment system. During tests, the pressure vessel was filled to 20% with water and then filled to 7.5 MPa with air. Upon being launched, the thrust produced by the pressure vessel was 5500 N and the pressure vessel reached a speed of 550 km/h in under 0.5 seconds after it was launched. The pressure vessel travelled to a recorded height or apogee of 835 m from the ground. This height is 33% (217 m) higher than the current Class A Water Rocket World Altitude Record and the new record from the above described pressure vessel was ratified on 7 Oct. 2015 subsequent to international peer review by the Water Rocket Achievement World Record Association. The previous record of 623 m, set in 2007 by U.S Water Rockets stood for 8 years.

The value of energy storage density held by the pressure vessel is 0.276 MJ, equivalent to 0.076 kWh. The energy storage density may vary depending on the pressure that the vessel is designed for.

The above description is by way of example only and it should be appreciated that numerous changes and modifications may be made to the pressure vessel and the method of making the pressure vessel without departing from the scope of the invention. For example, the tubular body can be constructed from any suitable material, preferably a composite material comprising fibres and a matrix. The stronger the fibre used as reinforcement, the higher the pressure per weight ratio of the pressure vessel. Preferably, the tubular body is constructed from a filament wound tube. The fibres need not be carbon fibres but may be glass-fibres, Kevlar fibres or any other suitable fibres. The composite material may be a hybrid composite that further includes a metal-matrix or a ceramic-matrix component, provided that the composite material has the desired properties to withstand high pressures and is suitably lightweight.

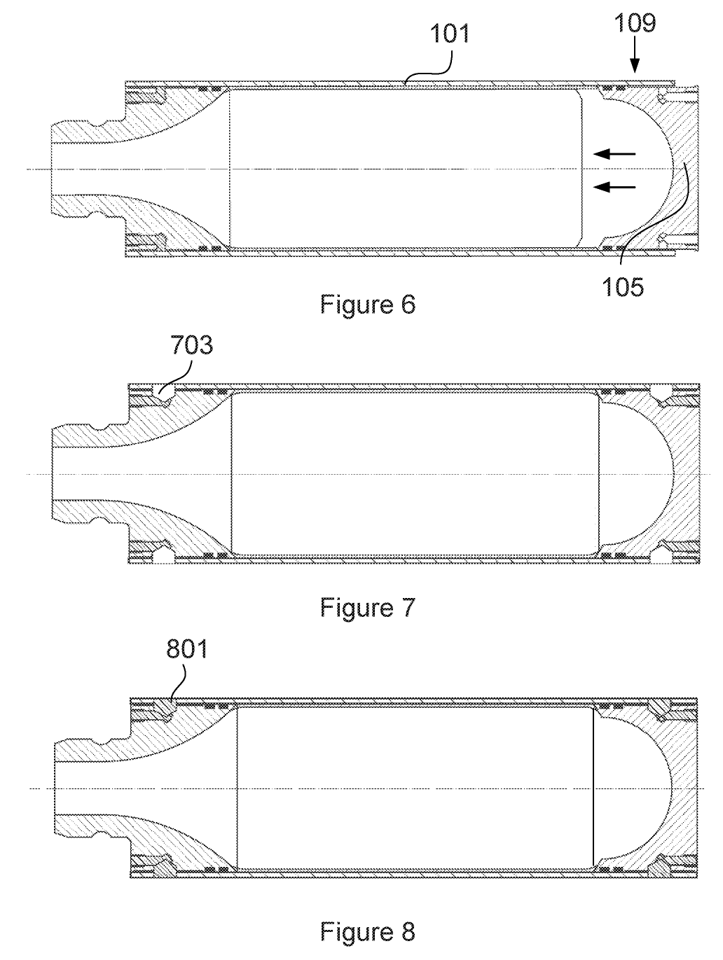

As a further modification, for example, as shown in FIGS. 6 to 9, where like features are indicated by like numerals, reinforcing studs (801) can be provided about the end caps (103, 105) in the following manner. Following the same steps described above, except for providing a reinforcing sleeve over the ends (107, 109), the first end cap (103) is secured in position, the flexible, fluid impervious lining provided and the second end cap (105) inserted and secured in the end (109) of the body (101) as shown in FIG. 6. Ten circumferentially spaced, radially extending sockets (703) are then formed in each end (107, 109) of the body (101), conveniently by drilling, as shown in FIG. 7. These are generally central of the channels (113). As shown in FIG. 8, the sockets (703) are filled with and epoxy adhesive (801). Once cured, the epoxy adhesive (801) forms studs which provide a mechanical bond which helps retain the end caps in position within the body once the pressure vessel is pressurised.

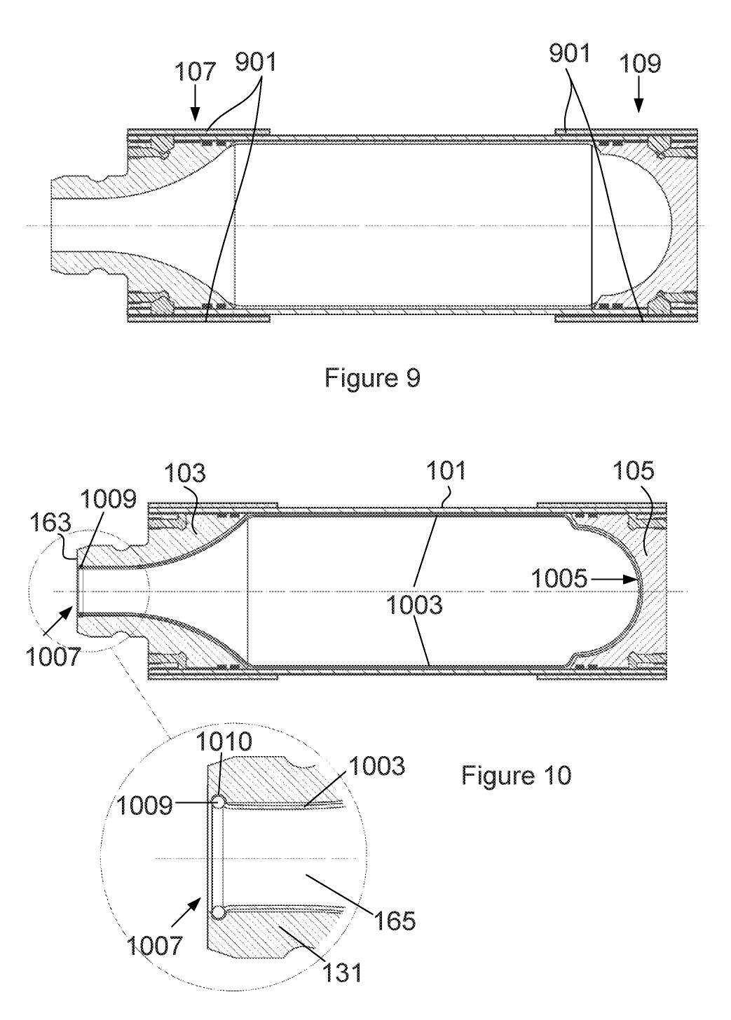

As shown in FIG. 9, sleeves (901) can further be provided over the ends (107, 109) as described above. The sleeves need not be made of carbon fibre composite, but may be made of any flexible and strong material that is sufficiently lightweight, preferably a composite material. The sleeve may be made of a composite cloth, tape or filament. Any fibre reinforcement, such as glass fibre, Kevlar or the like may form part of the composite material that the sleeve is made of. The stronger the fibre, the higher the pressure per weight ratio of the pressure vessel.

It will be understood that any suitable adhesive may be used to secure the end caps to the body, provided that the bond has the required shear strength to withstand the particular high pressure within the pressure vessel. For example, an adhesive with a shear strength of at least 20 MPa is adequate for a pressure vessel that is to be exposed to pressures of between approximately 10 MPa and 20 MPa. The adhesive must be able to adhere to and form a bond between the material that the end cap is made of and the material that the body is made of.

Many other embodiments will be apparent to those skilled in the art. For example, the end caps need not be made of plastics but can be made of a composite material, or a metal, such as aluminium. In the event that the end cap is made of plastics, it need not be made of PVC, but may be made from any plastics having relatively high strength per weight. The shape and size of the end caps may be modified depending on the application of the pressure vessel. The spout can be provided with a suitable valve if required, or the end caps provided with any other desirable configuration. In particular, an end cap, may be provided with a valve or may be configured to receive a valve assembly. An end cap may, for example be threaded so that a threaded valve may be screwed thereon.

The end caps could also be shaped to extend over the ends of the body to provide strengthening and possibly avoid the use of a further sleeve.

The fluid impervious lining can be provided in any suitable manner and any suitable material can be used. A great advantage over the prior art of the current vessel is that the lining is not required to be substantially rigid and have sufficient structural integrity to support a composite material body to be formed about it. This results in the lining of the current vessel being considerably lighter and more flexible than prior art linings. The lining will preferably have a thickness of less than 1 mm, more preferably less than 0.5 mm, most preferably about 0.2 mm or less.

In the event that a rubber lining is coated on the body, the rubber need not be a polyurethane rubber, but any suitable rubber can be used. A rubber that cures to a Shore A hardness of about 20 could be suitable, such as Latex for example.

It will be understood by those skilled in the art that the fluid impervious lining could also be provided by a thin and flexible sleeve. The sleeve could be closed at one end to form a bag or bladder and in this specification the term “sleeve” shall have its widest meaning and include a bag- or bladder-like shape.

As shown in FIG. 10, where like features are indicated by like numerals, the lining is provided by a sleeve (1003) having a closed end (1005) to form a bag and which is secured internally of the body (101). The sleeve (1003) has a complementary shape to that defined between the body (101) and end caps (103, 105) and is secured, in this embodiment, to the mouth (1007) of the spout (131) by a ring (1009) which provides a snap fit in a circumferential groove (1010) in the spout (131). Also in this embodiment, the sleeve (1003) is introduced into the body (101) in a deflated of folded condition through the spout (131) after the end caps (103, 105) have been secured to the body (131). Once in the body (101), the sleeve (1003) is inflated and then secured in position. If necessary, a breather tube (not shown) or similar arrangement can be used to permit air trapped between the sleeve (1003) and body (101) to escape before the sleeve (1003) is secured in position.

The sleeve may be made of any suitable elastic or an inelastic material, including foil material. In the event that inelastic material is used, the sleeve (1003) should be of larger internal volume than that of the tubular body (101) to permit expansion of the body under high pressures.

The sleeve could be secured in the body in any suitable manner. It could be adhesively secured to the sides of the body or secured at one or both ends, preferably to the end caps, either adhesively or mechanically or in any other suitable manner such as by heat or ultrasonic welding. Where the sleeve is removably secured it offers the advantage that it can easily be replaced to avoid contamination of the contents of the pressure vessel or to provide suitable resistance to different contents.

It will also be understood that the lining can be provided and end caps can be secured in place in any convenient order. For example, the end caps can both be secured in position and then the lining provided, or the lining provided and then the end caps secured in position, or one end cap secured in position, the lining provided and then the other end cap secured in position.

Depending on the application of the pressure vessel, the size and length to diameter ratio of the pressure vessel can be selected for optimal performance. Similarly, the wall thickness of the tubular body, for a fixed diameter of the pressure vessel, and the width of the circumferential channel to be filled with adhesive can be increased to improve the pressure capacity of the pressure vessel or vice versa.

An embodiment of the pressure vessel may be used as a rocket. Where the pressure vessel is used as a rocket it may be adapted in terms of its aerodynamics. For instance, the pressure vessel may be made to be long and thin as opposed to short and wide. In use, the pressure vessel is pressurised through the spout of the first end cap, while the end cap is coupled to a quick release coupling. The coupling includes a conduit for the flow of pressurised fluid into the vessel and a valve to store the compressed fluid prior to launch. The quick release couple is in order to launch the rocket. The fluid may be water or any other suitable fluid can be used as the propellant. Such rockets may find use in model rocketry.

The pressure vessel may also find use as a thruster for manoeuvring a satellite, or any other type of spacecraft.

Alternatively, the pressure vessel may be used for the storage of fluids at high pressures. The embodiment described above is suited to store any liquid or gas, or a mixture thereof that does not react with the rubber liner or with material of the end caps. The size and shape of the pressure vessel, in particular the thickness of the body, the size of the end caps and the thickness of the lining may be adapted to alter the pressure capacity of the pressure vessel to make it more suited towards a particular application.

In an alternative embodiment, the pressure vessel includes a tubular body made of a composite material which incorporates a flexible resin, such as a flexible epoxy resin. A flexible resin which forms part of the composite material will allow the resin to deform to an extent when subjected to high pressures without micro-cracks forming in the resin. In this manner the body of the pressure vessel remains fluid-impervious when it has been pressurised.

The end cap may have any shape and or configuration depending on the application of the pressure vessel. In another embodiment of the invention the end cap may be configured to receive a valve assembly, by for example including a threaded opening for receiving a threaded valve assembly. Alternatively the end cap itself may be provided with a valve. These embodiments are more suited to the application of the pressure vessel for the storage of fluid at high pressures within the pressure vessel.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A pressure vessel which includes a tubular body constructed from a composite material and a pair of end caps adhesively secured to opposite ends of the body, wherein a flexible, fluid impervious lining formed by a coating applied to the body is provided internally of the body.

2. The pressure vessel as claimed in claim 1, wherein the coating is a fluid elastomeric material which is applied to the body and cured to form the flexible, fluid impervious lining.

3. The pressure vessel as claimed in claim 1, wherein the lining has a thickness of less than 1 mm.

4. The pressure vessel as claimed in claim 1, wherein the end caps are secured, at least partially, within respective ends of the body.

5. The pressure vessel as claimed in claim 1, wherein each end cap provides a complementary fit within an end of the body and includes a circumferential channel wherein an adhesive in the circumferential channel adhesively secures the end cap in position.

6. The pressure vessel as claimed in claim 5, wherein one or more ports are provided in each end cap for introducing the adhesive in the circumferential channel with the end cap located within the body.

7. The pressure vessel as claimed in claim 5, wherein the adhesive is an epoxy adhesive.

8. The pressure vessel as claimed in claim 1, wherein the end caps are made from a fluid impervious plastics material.

9. The pressure vessel as claimed in claim 1, wherein the body is right cylindrical in shape.

10. The pressure vessel as claimed in claim 1, wherein the composite material is a carbon fibre composite material.

11. The pressure vessel as claimed in-claim 1, wherein a valve or spout is provided in at least one end cap.

12. A method of manufacturing a pressure vessel, the method including the steps of coating an internal surface of a tubular body made of a composite material to form a flexible, fluid impervious lining and adhesively securing an end cap to each end of the body.

13. The method as claimed in claim 12, wherein the internal surface of the body is coated with a fluid elastomeric material and the material is permitted to cure to form the flexible, fluid impervious lining.

14. The method as claimed in claim 12, wherein each end cap is secured in position by positioning the end cap within an end of the body so that the end cap is at least partially received within the end of the body and introducing an adhesive into a circumferential channel on the end cap such that the adhesive extends between the end cap and the internal surface of the body.

15. The method as claimed in claim 14, wherein the adhesive is introduced into the circumferential channel through one or more ports in the end cap.
